(19) United States
(12) Patent Application Publication
(10) Pub. No.: US 2022/0123951 A1
(43) Pub. Date: Apr. 21, 2022

(54) Certificate Management for Technical Installations

(71) Applicant: Siemens Aktiengesellschaft, Muenchen (DE)

(72) Inventors: Benjamin LUTZ, Pfinztal (DE); Anna PALMIN, Karlsruhe (DE)

(21) Appl. No.: 17/503,686

(22) Filed: Oct. 18, 2021

(30) Foreign Application Priority Data
Oct. 19, 2020 (EP) 20202646

(51) Int. Cl. H04L 9/32; H04L 9/08

(52) U.S. Cl. CPC H04L 9/3263; H04L 9/088

(57) ABSTRACT

A control system for a technical installation includes at least one certification authority and installation components, wherein the certification authority issues and revokes certificates and creates a certificate revocation list of already revoked certificates that can be distributed in the control system, where a certificate revocation list service is implemented which is configured to distribute the certificate revocation list to the installation component, installation components each comprise a local storage device in which filing of the previously distributed certificate revocation list is possible, and where the certificate revocation list service determines a revocation reason, and depending on the revocation reason, removal of a previously distributed certificate revocation list stored on the respective local storage device of the installation components is triggered such that after performance of the revocation storage of a newly created certificate revocation list in the respective local storage device of the installation components is initiated.

### BACKGROUND OF THE INVENTION

### 1. Field of the Invention

The invention relates to a control system for a technical installation, in particular a production installation or process installation and relates to a method for operating the technical installation.

### 2. Description of the Related Art

In the sphere of automation of a technical installation, such as a process installation, diverse protocols and mechanisms are used for a secure communication between the individual components of the technical installation, such as automating appliances, clients or servers. Most of these secure protocols and mechanisms require the use of “digital certificates”. The term a “certificate” in this case is understood in the current document to mean a digital data set that confirms specific characteristics (in this case of machines, appliances and/or applications). An authenticity and integrity of the certificate can be verified in general via cryptographic methods.

The certificates are issued by a certification body or certification authority. This is referred to in English as an “issuing CA (certification authority)”. A certification authority of this type is in general always online and provides, based on incoming certification applications, certificates for diverse candidates that it signs using its own certification authority certificate. The trustworthiness of the certification authority is ensured by virtue of the fact that the certification authority certificate of the certification authority is signed by the certificate of a trustworthy root certification body (also referred to as “root CA”) that is located in a secured environment. In this case, it is to be noted that the root CA is offline most of the time, and is only then activated or switched on—in compliance with the strictest security measures if the root CA is to issue a certificate for an associated certification authority.

It may happen that it is necessary to revoke a certificate or to simultaneously revoke multiple certificates. Such a revocation of a certificate that is issued by a certification authority (issuing certification authority (CA)) for an installation component always leads to the fact that this certificate is set by the relevant certification authority to a certificate revocation list (CRL) that contains all certificates that are no longer valid.

The updated or newly issued certificate revocation list is signed by the associated or relevant certification authority while using its private key and consequently qualifies as trustworthy.

It can be required that the revocation of certificates is performed as urgently as possible or must be performed immediately. One example for this is a defective and no longer repairable appliance that is to be disconnected from the network of a process installation. Here, it may be expedient for security reasons to place the certificate (or the certificates) that is or are used by the appliance on the corresponding certificate revocation list and consequently to render the certificate invalid.

It is rendered possible on account of an urgent revocation of the certificates that the appliance, on the one hand, can no longer communicate within the process installation (while using its operative certificates) and, on the other hand, can also no longer be provisioned outside the process installation (while using its manufacturer certificate).

In order for the installation components to be able to mutually validate their certificates, the trust chain in each case of the other components must be available to each of the components. Here, the trust chain regarding a certificate is formed from the certificate of the certification authority that has issued this certificate and from the certificates of the associated superordinate intermediate CAs and the associated root CA. In the case of the mutual certification validation, the certificates of their communication partner and also all the CA certificates that are contained in the associated trust chain are validated by the components. The validation of the revocation status of the respective (CA) certificate is an obligatory step during the validation. Here, a check is made to determine whether the certificate is published on the previously described certification revocation list (CRL) that is issued (and signed) by the relevant certification authority.

In general, the certificate revocation list is filed by the certification authority on a CRL distribution point (CDP) and the address or the URL of the CRL distribution point is adopted in the certificate. It is therefore possible, in principle, for each installation component itself to check the revocation status of its own certificate and also the certificates of their communication partner, because the installation component “retrieves” and checks the certificate revocation list of the CDP for whether the certificate revocation list possibly contains the respective certificate.

The, in general, particularly large amount of communication that occurs owing to the increased accesses to the CDPs can be reduced by virtue of the fact that each certificate revocation list “retrieved” by an installation component during the certification validation (in the step “testing the revocation status of a certificate”) from a distribution point or via a proxy is subsequently filed in the local cache of the installation component. In accordance with “Internet X.509 public key infrastructure certificate and certificate revocation list (CRL) profile” (request for comments (RFC) 5280 of the Internet Engineering Task Force (IETF)) in the case of checking the validity of a certificate (during the certificate validation) first of all it is checked as to whether the required certificate revocation list is provided locally and is valid (prior to accessing a CDP). The point in time at which this local caching of the certificate revocation list is provided, is referred to here as the local CRL caching point in time.

As a consequence, it is becomes possible that the installation component in the case of the next certification validation can first check for whether the required certificate revocation list is a) already contained and b) is up to date in its local cache, in other words whether it has not yet expired. Consequently, the access to the CDP or the CDP proxy is only required in the event of a) and/or b) not being fulfilled. While determining whether the certificate revocation list is up to date, in this case a check is performed to determine whether the prevailing point in time (referred to here as the point in time of the check) lies between the points in time “this update” and “next update” that are stated in the certificate revocation list. Here, the point in time at which this certificate revocation list was published is understood as “this update” and the point in time when the next certificate revocation list is issued is understood as “next update”.

By virtue of the fact that the point in time of the check (as the point in time of the check of the revocation status of a certificate) is between the point in time “this update” and the “next update” at the planned point in time that is stated in the associated certificate revocation list, it is to be rendered possible that the certificate revocation list is still up to date at the point in time of the check. It is however nevertheless possible that a certificate that is being currently checked for its revocation status has been revoked between the two points in time. This means that the associated certification authority (that has issued the certificate at an earlier point in time) has in fact already obtained the revocation application and has in response revoked the certificate. The updated certificate revocation list would, however, not be published immediately by the certification authority but rather would only be newly published at the point in time “next update” that is contained in the certificate revocation list.

This has the consequence that, in the case of the revalidation of this certificate (that is associated, for example, with a communications partner of the installation component), the relevant installation component “does not notice” that the certificate has been revoked in the meantime and this revoked certificate is accepted as valid. As a consequence, for example, the communication is subsequently rendered possible with a communication partner that is authenticated with reference to the (actually) revoked (and consequently no longer valid) certificate with respect to the installation component. This can potentially cause a significant weak point with respect to security, such as when the revocation of the certificate is performed as a consequence of a detected compromising of the associated private key of the communication partner.

It could thereby be possible to tackle the problem that the certification authority (for example, owing to adequate settings and/or scripts) is empowered to publish a certificate revocation list immediately after a certificate is revoked (at the point in time “this update”). The updated certificate revocation list could subsequently be distributed directly to the installation components. Here, it could be possible to completely (in a blanket manner) omit the local caching. This, however, would also bring the disadvantage that the communication in the technical installation would immensely increase (particularly in the case of a particularly high number of communication relationships).

WO 2017/144056 A1 discloses a method for improving information security from vehicle to X communication, where the vehicle to X communication can be secured via at least one certificate.

EP 3 287 925 A1 discloses a technical installation having a certificate-based communication securing arrangement of the installation components.

### SUMMARY OF THE INVENTION

It is an object of the invention to provide a control system for a technical installation, where certificate management of the control system can be operated in a resource conserving manner without, in this case, reducing the level of security of the technical installation.

This and other objects and advantages are achieved in accordance with the invention by a method for operating a technical installation, in particular a production installation or process installation, and a control system for the technical installation, where the control system in accordance with the invention comprises at least one certification authority and installation components, where the certification authority is responsible for issuing and revoking certificates for the installation components, where the certification authority is configured to create a certificate revocation list regarding certificates that are already revoked and the certificate revocation list can be distributed in the control system, and where a certificate revocation list service is implemented in the control system and the certificate revocation list service is configured to distribute the certificate revocation list to the installation component, and where the installation components in each case comprise a local storage device in which it is possible to file the previously distributed certificate revocation list.

The control system in accordance with the invention is characterized in that the certificate revocation list service is configured to determine a revocation reason after a certificate is revoked and to, depending on the revocation reason, initiate a removal of a previously distributed certificate revocation list that is stored on the respective local storage device of the installation components and after the revocation has been performed storing a newly created certificate revocation list in the respective local storage device of the installation components.

The term a “control system” in the present context is understood to mean a computer aided technical system that comprises functionalities for representing, operating and controlling a technical system, such as a production installation or manufacturing installation. The control system in the present case comprises at least one first installation component and one second installation component. Moreover, the control system can comprise “process-oriented” or “production-oriented” components that are used to control actuators or sensors.

The technical installation can be an installation from the process industry such as a chemical, pharmaceutical, petrochemical or an installation from the food industry or luxury food industry. As a consequence, any installations from the production industry, plants in which, for example, cars or goods of all types are produced are also included. Technical installations that are suitable for the implementation of the method in accordance with the invention can also come from the field of energy production. Wind turbines, solar installations or power plants for generating energy are likewise included in the term technical installation.

An installation component can be individual transducers for sensors or control devices for actuators of the technical installation. An installation component can however also be a combination of multiple such transducers or control devices, for example, a motor, a reactor, a pump or a valve system. Superordinate appliances, such as an automating appliance, an operator station server or a decentral peripheral, are likewise included under the term “installation components”. In this case, an automating appliance is a technical appliance that is used so as to realize an automation. The automating appliance in this case, for example, can be a storage programmable controller that represents a superordinate control function for subordinate controllers. The term an “operator station server” in the present case is understood to mean a server that captures central data of an operating and monitoring system and also in general alarm and measured value archives of a control system of a technical installation and provides the data and alarm and measured value archives to users. The operator station server in general produces a communication connection to automation systems (e.g., an automating appliance) of the technical installation and relays data of the technical installation to “clients”, where the data is used to operate and monitor operation of the individual functional elements of the technical installation.

The issuing certification authority (CA) can also be referred to as an “issuing CA (certification authority)” and provides, based on incoming certification applications, certificates for diverse candidates that it signs using its own certificate. The trustworthiness of the certification authority is ensured by virtue of the fact that its own certificate is signed by the certificate of a trustworthy root certification authority (also referred to as “root CA”) that is located in a secure environment. The certification authority is not just capable of issuing certificates but can also withdraw the certificates. A corresponding revocation application is, in general, required for the certification authority to perform the revocation or withdrawal of a certificate. This revocation application can be provided, for example, by the installation component itself, whose certificate is to be revoked, or by a proxy (e.g., a registration authority (RA)). Alternatively, the certificate can be revoked by a user directly at the CA.

The term a “certificate” is understood to mean a digital data set according to the standard X.509 (RFC 5280) that confirms specific characteristics (in this case, e.g., machines, appliances and/or applications). An authenticity and integrity of the certificate can be verified, in general, via cryptographic methodologies. A certificate can be an operative certificate that is used for a communication between different installation components of the technical installation or a component inherent certificate that connects the component for example to its manufacturer or the respective customer environment and consequently is referred to as manufacturer appliance certificate or customer appliance certificate.

A certificate revocation list (CRL) in the present context is a list of certificates and this list is created by the certification authority. The certificate revocation list comprises the certificates that the certification authority has withdrawn as invalid (and thereby not trustworthy). It is also possible within the scope of the present invention that the technical installation comprises multiple certification authorities that each create a dedicated certificate revocation list regarding certificates that have been withdrawn by the certification authorities.

The control system in accordance with the invention comprises a certificate revocation list service that, depending on a reason for a previous revocation of a certificate by the certification authority, ensures a distribution of the newly created certificate revocation list by the certification authority as a reaction to the revocation that is performed.

In this regard, the certificate revocation list service can comprise a predeterminable configuration (this can also be derived automatically from the method technical communication dependencies of the projected installation components) and it is possible via the configuration, for example, to determine with which certification authorities (or with which internal or external distribution points) the certificate revocation list service is to establish contact so as to acquire certificate revocation lists.

The distribution of the updated certificate revocation lists is not performed automatically at all the installation components that are provided in the technical installation (this would necessitate a considerable communication outlay). On the contrary, the certificate revocation list service transmits a simple message to the installation participant in the presence of specific previously defined revocation reasons, and the message triggers removal of the (old) certificate revocation list that is stored in the respective local storage device of the installation participant. In this case, in other words, this is a request for the installation participant to remove the old certificate revocation list from its local storage device.

This means that the installation components in the case of the next validation of an (arbitrary) certificate that is issued by the certification authority can no longer find a certificate revocation list of the associated certification authority in the local storage device and is consequently “forced” for this purpose to obtain the up-to-date certificate revocation list via the relevant certificate revocation list service. As a consequence, the certificate revocation list service “initiates” storage of the newly created certificate revocation list in the local storage device of the installation component that is affected by the coming validation of a certificate without the need for the certificate revocation list service to send the updated certificate revocation list to all the installation components in a blanket manner.

The reaction to a revocation reason being present can be projected or configured in the control system.

The control system in accordance with the invention makes it possible to provide improved certificate management because certificate revocation lists are stored precisely and selectively in the local storage devices of the installation components. The invention can thereby provide a valid contribution to the maintenance of the normal operation and the availability of technical installations without endangering the security level of the installations. In this case, should be noted that the availability in accordance with the International Electrotechnical Commission (IEC) international standard 62443 (as the leading industrial security standard) is the uppermost protective aim.

A revocation reason that is to lead to removal of the certificate revocation list in the respective local storage device of the installation components can represent, for example, a compromise of a private key of an installation component of the control system or a change in ownership of the revoked certificate or blockage of the revoked certificate or a compromise of a private key of an identity provider of the revoked certificate. It can, however, also be another revocation reason (for example, a revocation reason according to RFC 5280), for example another appliance specific and/or installation specific revocation reason.

It is also an object of the invention to provide a method for operating a technical installation, in particular a production installation or process installation, having a control system, where the control system comprises at least one certification authority and installation components. The method comprises:
a) revoking a certificate of an installation component by the certification authority;
b) creating a certificate revocation list regarding certificates that are already revoked, the certificate revocation list comprising the previously revoked certificate;
c) determining a revocation reason for the revocation of the certificate, which is previously performed by the certification authority;
d) depending on the revocation reason, initiating a removal of the previously distributed certificate revocation list that is stored on the respective local storage device of the installation components; and
e) initiating storage of a newly created certificate revocation list in the respective local storage device of the installation components after the revocation is performed.

In this case, a revocation reason that is to lead to removal of the certificate revocation list in the respective local storage device of the installation components can represent a compromise of a private key of an installation component of the control system or a change in ownership of the revoked certificate or blockage of the revoked certificate or a compromise of a private key of an identity provider of the revoked certificate.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described characteristics, features and advantages of this invention and also the manner in which these are achieved become clearer and more explicitly understandable in conjunction with the following description of an exemplary embodiment that is further explained in conjunction with the drawings, in which:

FIG. 1 is a schematic block diagram a portion of a part of a control system configured as a process installation in accordance with the invention; and

FIG. 2 is a flowchart of the method in accordance with the invention.

### DETAILED DESCRIPTION OF THE EXEMPLARY EMBODIMENTS

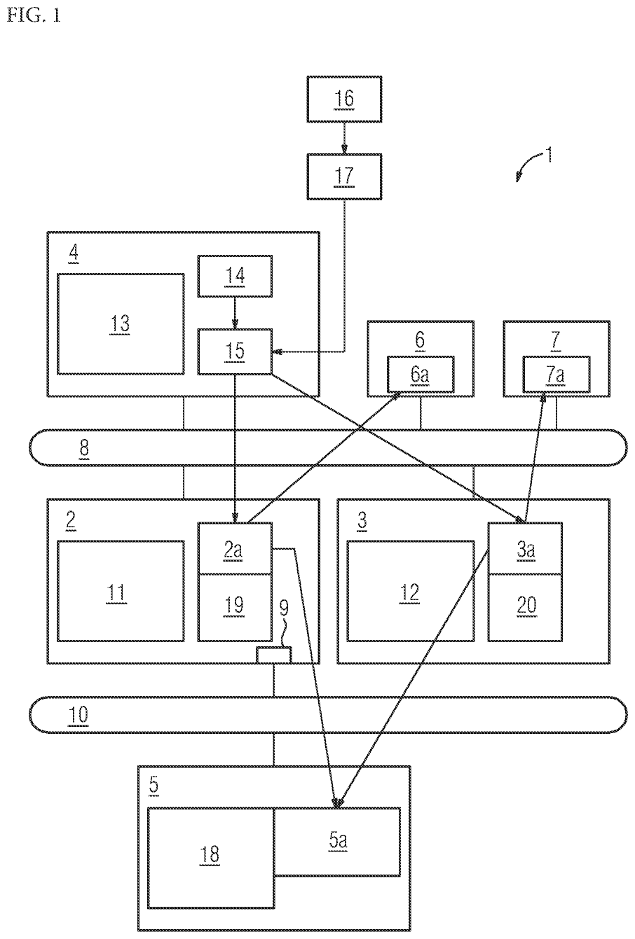

FIG. 1 is an illustration of a portion of a control system 1 in accordance with the invention of a technical installation that is formed as a process installation, in other words method technical installation. The control system 1 comprises an engineering station server 2, an operator station server 3, an administration station server 4, an automating station 5, an engineering station client 6 and an operator station client 7.

The operator station server 3, the engineering station server 2, the administration station server, the engineering station client 6 and the operator station client 7 are connected to one another via a terminal bus 8 and optionally are connected to further components (not illustrated) of the control system 1, such as a process data archive.

A user or operator can access the operator station server 3 to operate and monitor via the operator station client 7 via the terminal bus 8. A project engineer or operator has access to the engineering station server 2 via the engineering station client 6 via the terminal bus 8 in the context of an engineering/making a project/configuring the process installation. The terminal bus 8 can be formed, for example, as an industrial Ethernet without being limited to this.

The engineering station server 2 has an interface 9 that is connected to an installation bus 10. It is possible via this interface 9 for the engineering station server 2 to communicate with the automating station 5 and also with optionally provided further components of the process installation. The installation bus 10 can configured, for example, as an industrial Ethernet without being limited to this. The automating station 5 can be connected to an arbitrary number of subsystems (not illustrated).

An automating configuration 11 in relation to the automating station 5 that is to be automated is stored on the engineering station server 2. Here, this can be, for example, a CFC plan. Within the scope of the “engineering projects”, in this case, it is determined how the automating station 5 itself and with other installation components such as appliances, transducers, sensors and/or actuators, are to react and also communicate.

A run time environment 12 is implemented on the operator station server 3 and the run time environment allows special programs for operating and monitoring the process installation to run on a suitable platform.

A management service 13 is implemented on the administration server 4, in other words a management server, and the management service can be used, for example, so as to make an inventory or to plan updates for installation components of the process installation. Moreover, a certification authority 14 and a certificate revocation list service 15 is implemented on the administration server 4. The certification authority 14 is responsible for issuing and revoking certificates for the individual installation components 2, 3, 4, 5, 6, 7 of the process installation.

If a certificate of an installation component 2, 3, 4, 5, 6, 7 of the certification authority 14 is declared void, i.e., is revoked, then the certification authority 14 creates a certificate revocation list and at least the certificate that is previously declared void is listed on the certificate revocation list. The certificate revocation list service 15 monitors the creation of new certificate revocation lists and retrieves this certificate revocation list when required by the certification authority. In addition, the certificate revocation list service 15 can also obtain certificate revocation lists from an external certification authority 16 (outside of the process installation) and the certificate revocation lists are stored, for example, at a distribution point 17.

The certificate revocation list service 15 takes the reason for the revocation of a certificate that is previously made from the certificate revocation list. The revocation reason can be determined, for example, via special monitoring services 18, 19, 20 that monitor the revocation applications that are made by installation components 2, 3, 4, 5, 6, 7 to the certification authority 14. Depending on the revocation reason, the certificate revocation list service 15 initiates a removal of a previously distributed certificate revocation list that is stored on the respective local storage device of the installation components.

“Distributed” in this case does not inevitably mean that the certificate revocation list has been previously actively transmitted to the installation components 2, 3, 4, 5, 6, 7. On the contrary, the installation components 2, 3, 4, 5, 6, 7 advantageously comprise a certificate revocation list distributing service 2a, 3a, 5a, 6a, 7a that has the task of obtaining an updated certificate revocation list from the certificate revocation list service 15.

If a certificate revocation list has been removed from a local storage device of an installation component 2, 3, 4, 5, 6, 7 and the installation component 2, 3, 4, 5, 6, 7 for the purpose of the construction of a communication relationship with another installation component 2, 3, 4, 5, 6, 7 wishes to validate the certificate of the other installation component, then the installation component “notices” that it no longer has an up-to-date certificate revocation list and ensures, in particular by the certificate revocation list service 2a, 3a, 5a, 6a, 7a, to obtain a new up to date certificate revocation list from the certificate revocation list service 15.

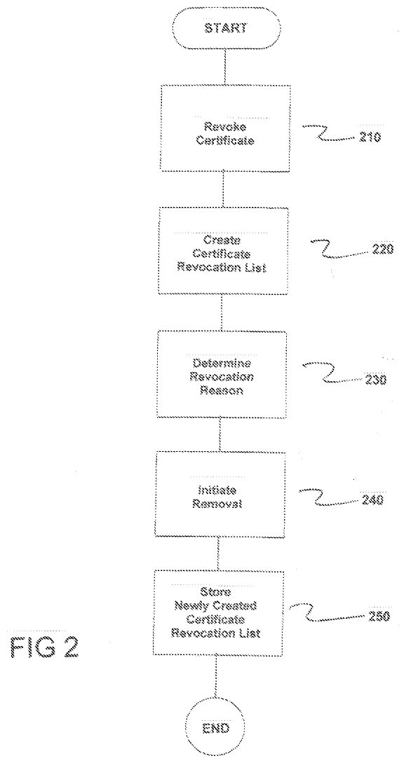

FIG. 2 is a flowchart of the method for operating a technical installation having a control system 1 comprising at least one certification authority and installation components 2, 3, 4, 5, 6, 7. The method comprises a) revoking a certificate of an installation component 2, 3, 4, 5, 6, 7 by the certification authority 14, 16, as indicated step 210.

Next, b) a certificate revocation list regarding certificates which are already revoked is created, as indicated in step 220. In accordance with the invention, the certificate revocation list comprises the previously revoked certificate.

Next, c) a revocation reason for the revocation of the certificate, which is previously performed by the certification authority 14, 16, is determined, as indicated in step 230.

Next, d) initiating, depending on the revocation reason, a removal of the previously distributed certificate revocation list which is stored on the respective local storage device of the installation components 2, 3, 4, 5, 6, 7 is initiated, as indicated in step 240.

Next, e) storage of a newly created certificate revocation list in the respective local storage device of the installation components 2, 3, 4, 5, 6, 7 after the revocation is performed is initiated, as indicated in step 250.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claim is:

1. A control system for a technical installation, comprising:
at least one certification authority; and
installation components;
wherein the certification authority issues and revokes certificates for the installation components;
wherein the certification authority is configured to create a certificate revocation list of certificates which are already revoked, said certificate revocation list being distributable in the control system;
wherein a certificate revocation list service is implemented in the control system, said certificate revocation list service being configured to distribute the certificate revocation list to the installation component;
wherein the installation components each comprise a local storage device in which the previously distributed certificate revocation list are fileable; and
wherein the certificate revocation list service is configured to determines a revocation reason after a certificate is revoked by drawing on a revocation application or a corresponding user input and, depending on the revocation reason, trigger a removal of the previously distributed certificate revocation list stored on a respective local storage device of the installation components such that, after the revocation has been performed, storage of a newly created certificate revocation list in the respective local storage device of the installation components is initiated.

2. The control system as claimed in claim 1, wherein a revocation reason that is to lead to the removal of the certificate revocation list in the respective local storage device of the installation components represents one of (i) compromise of a private key of an installation component of the control system, (ii) change of ownership of the revoked certificate, (iii) blockage of the revoked certificate and (iii) compromise of a private key of an identity provider of the revoked certificate.

3. The control system as claimed in claimed 1, wherein the control system comprises a production installation or process installation.

4. A method for operating a technical installation having a control system comprising at least one certification authority and installation components, the method comprising:
a) revoking a certificate of an installation component by the certification authority;
b) creating a certificate revocation list regarding certificates which are already revoked, said certificate revocation list comprising the previously revoked certificate;
c) determining a revocation reason for the revocation of the certificate, which is previously performed by the certification authority;
d) initiating, depending on the revocation reason, a removal of the previously distributed certificate revocation list which is stored on the respective local storage device of the installation components; and
e) initiating storage of a newly created certificate revocation list in the respective local storage device of the installation components after the revocation is performed.

5. The method as claimed in claim 3, wherein a revocation reason which is to lead to a removal of the certificate revocation list in the respective local storage device of the installation components represents comprises one of (i) compromise of a private key of an installation component of the control system, (ii) change of ownership of the revoked certificate, (iii) blockage of the revoked certificate and (iv) compromises of a private key of an identity provider of the revoked certificate.

6. The method as claimed in claim 3, wherein the control system comprises a production installation or process installation.
